(19) United States
(12) Patent Application Publication
(10) Pub. No.: US 2017/0101316 A1
(43) Pub. Date: Apr. 13, 2017

(54) SYSTEM FOR PRODUCTION OF CARBON AND NET HYDROGEN LIQUID FUELS

(71) Applicant: ADVANCED GREEN TECHNOLOGIES, LLC, Chandler, AZ (US)

(72) Inventor: Roy Edward McAlister, Phoenix, AZ (US)

(21) Appl. No.: 15/314,921

(22) PCT Filed: May 29, 2015
(86) PCT No.: PCT/US15/33361

§ 371 Date: Nov. 29, 2016

Related U.S. Application Data
(60) Provisional application No. 62/004,802, filed on May 29, 2014.

(51) Int. Cl. C01B 31/02; C01B 3/24; C10L 8/00

(52) U.S. Cl. CPC C01B 31/02; C01B 3/24; C10L 8/00; C01B 2203/0272; C01B 2203/0833; C01B 2203/0811; C01B 2203/1241; C10L 2290/24; C10L 2290/02

(57) ABSTRACT

The present disclosure provides methods for producing carbon and a net hydrogen liquid fuel from a carbon donor substance and a hydrogen donor substance.

### TECHNICAL FIELD

This application relates to techniques, methods, and systems related to for producing carbon and net hydrogen liquid fuels, for example by anaerobic dissociation of hydrocarbons.

### BACKGROUND

Methane concentration in the global atmosphere has more than doubled during the Industrial Revolution. A molecule of methane produces twenty to seventy times greater greenhouse warming and harmful stratospheric ozone destruction compared to a molecule of carbon dioxide. Increasingly large amounts of methane are released by erosion of soils that contain organic substances and from landfills, farm wastes, forest residues, and the fossil fuel industry. Much larger releases of methane are threatened by further greenhouse warming of vast permafrost and ocean bottom deposits of methane hydrates as ocean currents are modified.

Thermal dissociation of hydrocarbons (CₓH_{y}) such as methane to produce carbon and hydrogen provides attractive economic development opportunities. Illustratively anaerobic thermal dissociation of methane requires about 75 kJ/mole as shown by Equation 1.

CH₄+Heat→C+2H₂ (Heat=74.9 kJ/mole) Equation 1

Table 1 compares the thermal energy requirements for production of hydrogen by various approaches, one of which co-produces carbon (i.e. anaerobic dissociation¹ of a hydrogen and carbon donor such as a hydrocarbon.)

TABLE 1
ENERGY REQUIREMENT PER MOLE OF HYDROGEN

| RESOURCE | PROCESS | REACTION | THERMAL ENERGY REQUIREMENT | |
|---|---|---|---|---|
| METHANE | DISSOCIATION¹ | CH₄→C + 2H₂ | 75 kJ/MOLE (H₂) | 800-1000° C. |
| METHANE | STEAM REFORMATION | CH₄ + 2H₂O→CO₂ + 4H₂ | 125 kJ/MOLE (H₂) | 800-1000° C. |
| WATER | DISSOCIATION | H₂O → H₂ + .5O₂ | 567 kJ/MOLE (H₂) | 2800-3000° C. |
| WATER | ELECTROLYSIS | H₂O → H₂ + .5O₂ | 1700 kJ/MOLE (H₂) | @ POWER PLANT² |
| COAL | STEAM REFORMATION | C + 2H₂O→CO₂ + 2H₂ | 175 kJ/MOLE (H₂) | 1000-1500° C. |

¹Anaerobic dissociation of hydrocarbons efficiently produce carbon and hydrogen.
²Requires about 3 times more combustion energy at the power plant to make the electricity required for electrolysis.

In addition to requiring the least amount of thermal energy per mole of hydrogen production, anaerobic dissociation of hydrocarbons such as methane can provide collection of carbon that may be utilized to make durable goods. It is highly desirable to produce hydrogen without releases of greenhouse gases such as CO₂ or carbonaceous particulates and to co-produce valuable carbon.

Previous thermal dissociation efforts have been practiced as variously aerobic systems that wastefully burned the hydrogen to make carbon or burned the carbon to make hydrogen along with troublesome releases of greenhouse gases and particles. This has provided carbon black for purposes such as pigmentation, opacity, U.V. protection and as reinforcing filler in plastics and rubber products such as tires. In other instances it has provided hydrogen for chemical processes including production of ammonia and urea. However such wasteful processes have continued to be notorious sources of carcinogens, air and water pollution.

### SUMMARY

The present disclosure provides systems and methods for producing carbon and net hydrogen liquid fuels, for example by anaerobic dissociation of hydrocarbons. In some embodiments, the system and/or methods utilize concentrated solar energy. In some embodiments, the hydrocarbon comprises natural gas, propane, ethane, methane, or combinations thereof. In some embodiments the systems include electric resistance elements, induction heating susceptors, and/or flame radiation and/or conduction from combustion of a suitable fuel.

In one embodiment, the present technology provides a method of producing carbon and a net hydrogen liquid fuel, the method comprising providing a hydrocarbon, mixing an oxidant with the hydrocarbon to form a mixture, and combusting the mixture in the presence of hydrogen to form the carbon and the net hydrogen liquid fuel.

In another embodiment, the present technology provides a method of producing a net hydrogen liquid fuel, the method comprising providing a mixture of hydrogen and a hydrocarbon, anaerobically dissociating the hydrocarbon in the presence of heat and/or an oxidant to form carbon and the net hydrogen liquid fuel, and collecting and/or using the net hydrogen liquid fuel.

In yet another embodiment, the present technology provides a method of producing carbon and a net hydrogen liquid fuel, the method comprising providing a carbon donor substance, combining a hydrogen donor substance with the carbon donor source, and anaerobically dissociating the hydrocarbon in the presence of heat and/or an oxidant to form carbon and the net hydrogen liquid fuel.

In another embodiment, the present technology provides a method of producing carbon and a net hydrogen liquid fuel, the method comprising providing methane, combining an oxidant with the methane to form a mixture, and combusting the mixture in the presence of hydrogen to form carbon and the net hydrogen liquid fuel.

### BRIEF DESCRIPTION OF THE DRAWINGS

FIGS. 1A-C illustrate methods for producing a net hydrogen fuel according to the present technology.

FIG. 2A illustrates a method for producing carbon and a net hydrogen liquid fuel according to the present technology.

FIG. 2B illustrates a method for producing and collecting carbon and producing a net hydrogen liquid fuel according to the present technology.

FIG. 2C illustrates a method for producing, collecting and/or using a net hydrogen liquid fuel according to the present technology.

FIG. 3A illustrates a method for producing, collecting and/or using a net hydrogen liquid fuel according to the present technology.

FIG. 3B illustrates a method for producing and collecting carbon and producing a net hydrogen liquid fuel according to the present technology.

FIG. 3C illustrates a method for producing, collecting and/or using a net hydrogen liquid fuel according to the present technology.

FIG. 4A illustrates a method for producing carbon and a net hydrogen liquid fuel according to the present technology.

FIG. 4B illustrates a method for producing, collecting and/or using a net hydrogen liquid fuel according to the present technology.

FIG. 4C illustrates a method for producing, collecting and/or using a net hydrogen liquid fuel according to the present technology.

FIG. 5A illustrates a method for producing carbon and a net hydrogen liquid fuel according to the present technology.

FIG. 5B illustrates a method for producing and collecting carbon and producing a net hydrogen liquid fuel according to the present technology.

FIG. 5C illustrates a method for producing, collecting and/or using a net hydrogen liquid fuel according to the present technology.

### DETAILED DESCRIPTION

Various sources of heat and delivery systems are suitable for anaerobic dissociation of hydrocarbons such as concentrated solar energy, natural gas, propane, ethane or methane including systems with electric resistance elements, induction heating susceptors, and flame radiation and/or conduction from combustion of a suitable fuel.

Systems for producing a mixture of carbon and a net hydrogen liquid fuel are disclosed, for example, in U.S. patent application Ser. No. 14/290,789, attorney docket no. 69545-8408.US01, filed on May 29, 2014, and incorporated by reference in its entirety herein.

Various examples of methods for producing carbon and a net hydrogen liquid fuel will now be described in further detail. The following description provides specific details for a thorough understanding and enabling description of these examples. One skilled in the relevant art will understand, however, that the techniques discussed herein may be practiced without many of these details. Likewise, one skilled in the relevant art will also understand that the technology can include many other features not described in detail herein. Additionally, some well-known steps, structures or functions may not be shown or described in detail below so as to avoid unnecessarily obscuring the relevant description.

The terminology used below is to be interpreted in its broadest reasonable manner, even though it is being used in conjunction with a detailed description of some specific examples of the embodiments. Indeed, some terms may even be emphasized below; however, any terminology intended to be interpreted in any restricted manner will be overtly and specifically defined as such in this section.

Various urban legends suggest that the amount of energy that could possibly be supplied from biomaterials including organic wastes and energy crops is insufficient to replace present production of energy by fossil fuels. These legends are untrue but widely believed because of the myopic assumption that carbon in such feedstock materials is combusted one-time to produce energy.

Embodiments are disclosed for sustainable energy production that substantially exceeds one-time combustion of fossil fuels. Present embodiments provide for sustainable energy production by carbon-enhanced equipment. Carbon for reinforcing or otherwise enhancing the capabilities and performances of energy conversion equipment is extracted from organic wastes and energy crops and/or methane from decaying permafrost and/or oceanic deposits of clathrates (particularly methane hydrates) and/or from fossil fuels.

This allows cost-effective production and applications of carbon-reinforced or otherwise enhanced components and equipment to harness solar, wind, moving water, geothermal and other energy resources. Illustratively carbon reinforced wind and water turbines and/or other equipment such as ocean thermal energy conversion systems can harness far more than 1000 times the amount of energy produced by one-time sacrificial burning of such carbon. Carbon for enabling sustainable energy conversion practices is co-produced along with hydrogen from such carbon and hydrogen donor materials.

In many ways hydrogen is an ideal fuel that combusts in a wide range of air/fuel ratios, produces about three-times more heat per mass unit than petrol fuels such as gasoline, jet and diesel fuels. Hydrogen can be substituted for gasoline and diesel fuel by various combinations of the present embodiments to overcome production of carbon particles, carbon monoxide, carbon dioxide, oxides of nitrogen, and sulfur-based pollutants.

However the specific energy storage density (e.g. combustion mega-joules per volume or MJ/Liter) of gaseous hydrogen at ambient temperature and pressure is about 3,700 times lower than liquid diesel fuel and 3,400 times less than gasoline. Further, in comparison with liquid hydrocarbon fuel compounds, hydrogen molecules are much smaller and present far lower bulk viscosity to readily leak and escape through previously ignored defects that would not allow leakage of petrol fuels from fuel tanks.

The present embodiments facilitate the production of and applications of “net hydrogen liquid fuels” for sustainable economic development that otherwise will be increasingly lost as the growing vehicle production as shown is dedicated to fossil-sourced gasoline and diesel fuels. Typical processes for converting carbon donor substances such as C_{X}H_{Y} including fossil and renewable compounds into valuable carbon based durable goods particularly include carbon-reinforced equipment. In the processes summarized “xC” depicts carbon enhanced equipment that delivers many times more energy than can be released by combustion, whereby the xC application provides sustainable conversion of solar, wind, moving water, and geothermal energy sources along with co-production of hydrogen.

As used herein, the term “hydrocarbon” refers to a compound having a general formula of C_{X}H_{Y}. For example and without limitation, the term “hydrocarbon” as used herein includes, but is not limited to, methane, ethane, propane, butane, pentane, hexane, heptane, octane, nonane, and decane, in branched and/or unbranched configurations, or any other branched or unbranched compound of general formula C_{X}H_{Y}, any combination thereof, or mixtures thereof, for example natural gas, fossil natural gas, waste digester gas, permafrost or landfill-sourced methane, or combinations thereof.

As used herein, the term “oxidant” refers to an element, compound, ion or radical capable of oxidizing a hydrocarbon. For example and without limitation, the term “oxidant” as used herein includes, but is not limited to, oxygen, ozone, NO_{X}, OH⁻, air, an oxidizing exhaust gas, or a combination of any of the foregoing.

In various embodiments, the present technology provides methods for dissociating (e.g., anaerobically dissociating) a hydrocarbon. Equation 1A illustrates such a process.

C_{X}H_{Y} +Heat→xC+(0.5y)H₂ Equation 1A

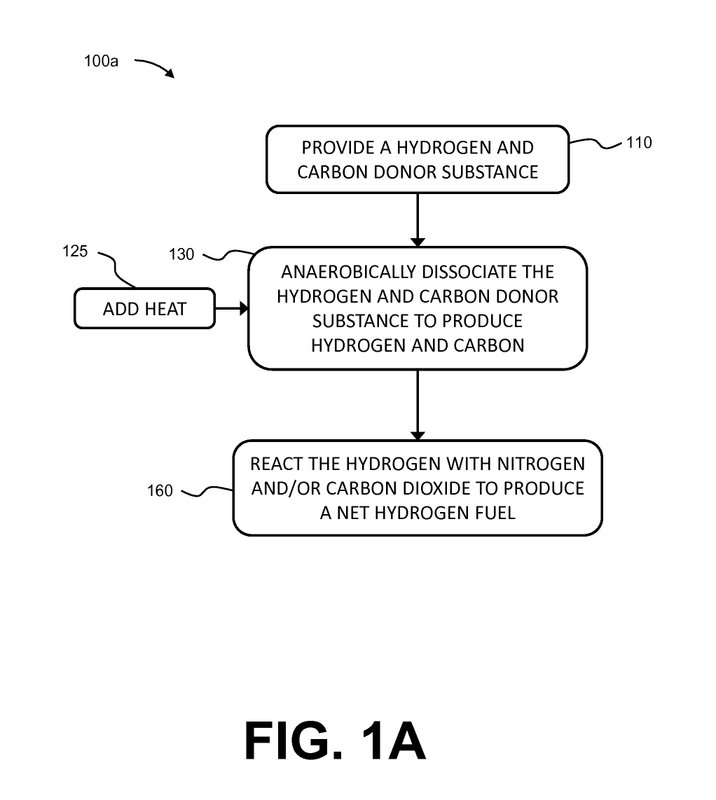

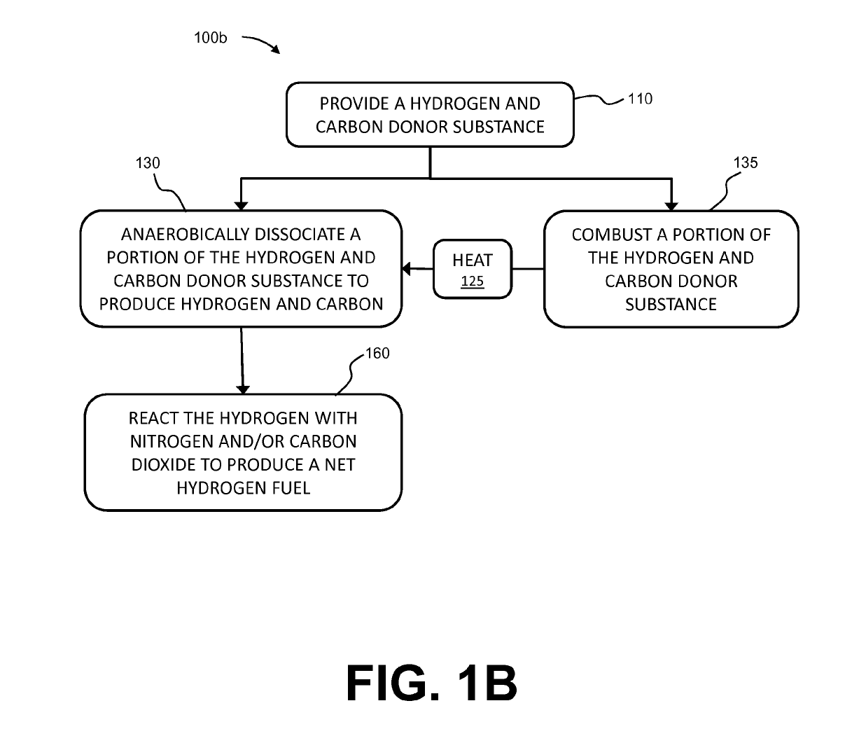

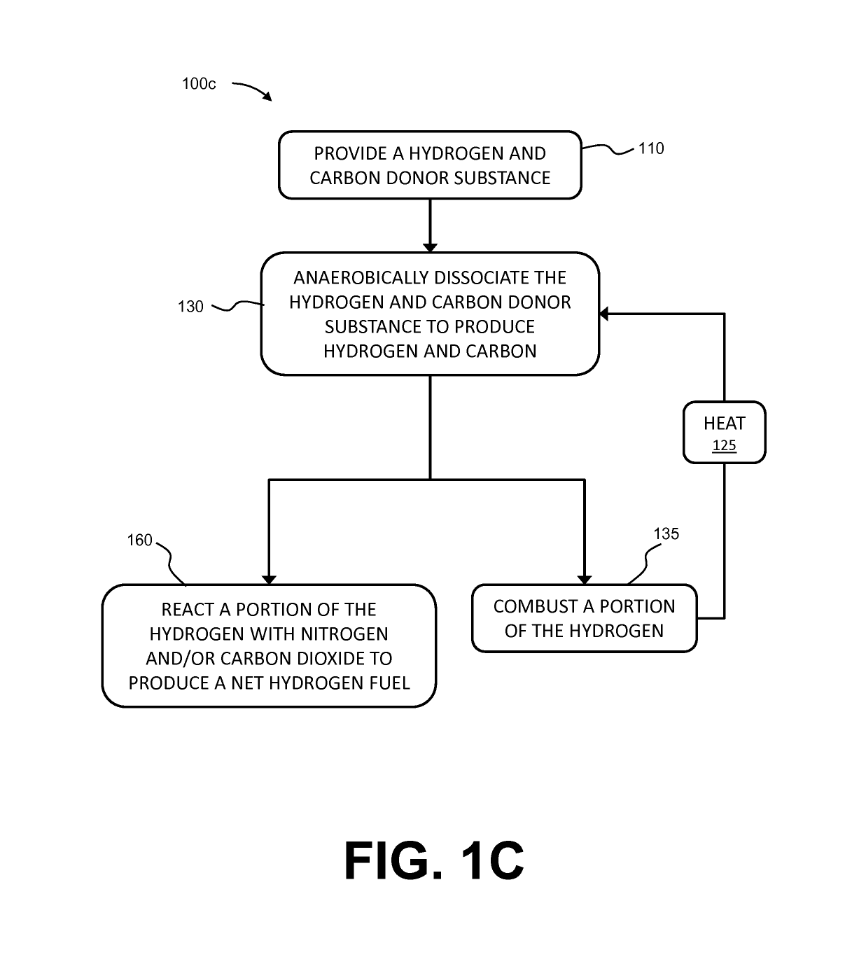

Referring now to FIG. 1A, a method 100a for producing a net hydrogen fuel includes a process 110 for providing a substance that is capable of donating hydrogen and carbon upon anaerobic dissociation (a “hydrogen and carbon donor substance”). Method 100a further includes a process 130 for anaerobically dissociating the hydrogen and carbon donor substance to produce hydrogen and carbon. In some embodiments, the anaerobic dissociation process 130 includes a process 125 for adding heat to the hydrogen and carbon donor substance. In a process 160, the hydrogen produced in process 130 is reacted with nitrogen and/or carbon dioxide to produce the net hydrogen fuel. The nitrogen and/or carbon dioxide can be provided from any suitable source including, for example, the exhaust pipes or smoke stacks of power plants, bakeries, breweries, ethanol plants, limestone calcinators, destructive distillation processors, and/or anaerobic digesters including purified or semi-purified gas reservoirs, or the air. This enables net hydrogen fuels to be produced that can be transported in conventional pipelines and/or contained by tanks designed for gasoline, diesel fuel, ethane, propane, butane, and/or liquefied or compressed methane or hydrogen.

In a variation shown in FIG. 1B, a method 100b for producing a net hydrogen fuel includes a process 110 for providing a hydrogen and carbon donor substance. In process 135, a portion of the hydrogen and carbon donor substance is combusted (e.g., in a fuel cell, heat engine, or combustor) to produce heat which is provided by process 125 to heat the anaerobic dissociation process 130.

As shown in the variation depicted in FIG. 1C, a method 100c for producing a net hydrogen fuel includes a process 110 for providing a hydrogen and carbon donor substance. The hydrogen and carbon donor substance is anaerobically dissociated in a process 130 to produce hydrogen and carbon. A portion of the hydrogen formed in process 130 is then reacted with nitrogen and/or carbon in process 160 as described above with respect to method 100a (FIG. 1A), while at least a portion of the hydrogen formed in process 130 is combusted (e.g., in a fuel cell, heat engine, or combustor) in process 135 to produce heat which is provided via process 125 to heat the anaerobic dissociation process 130.

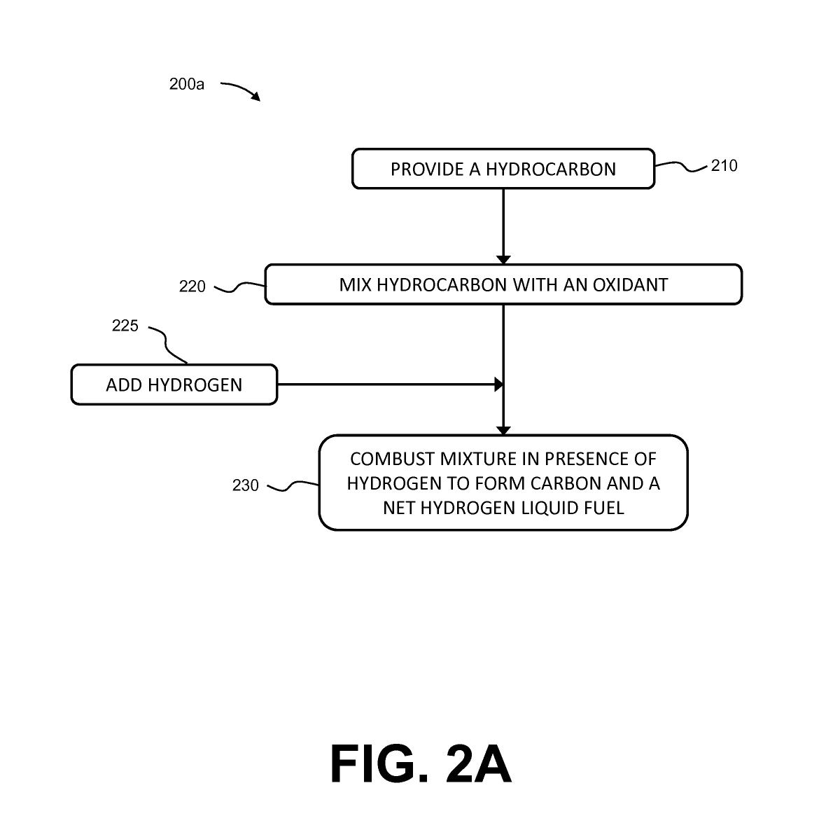

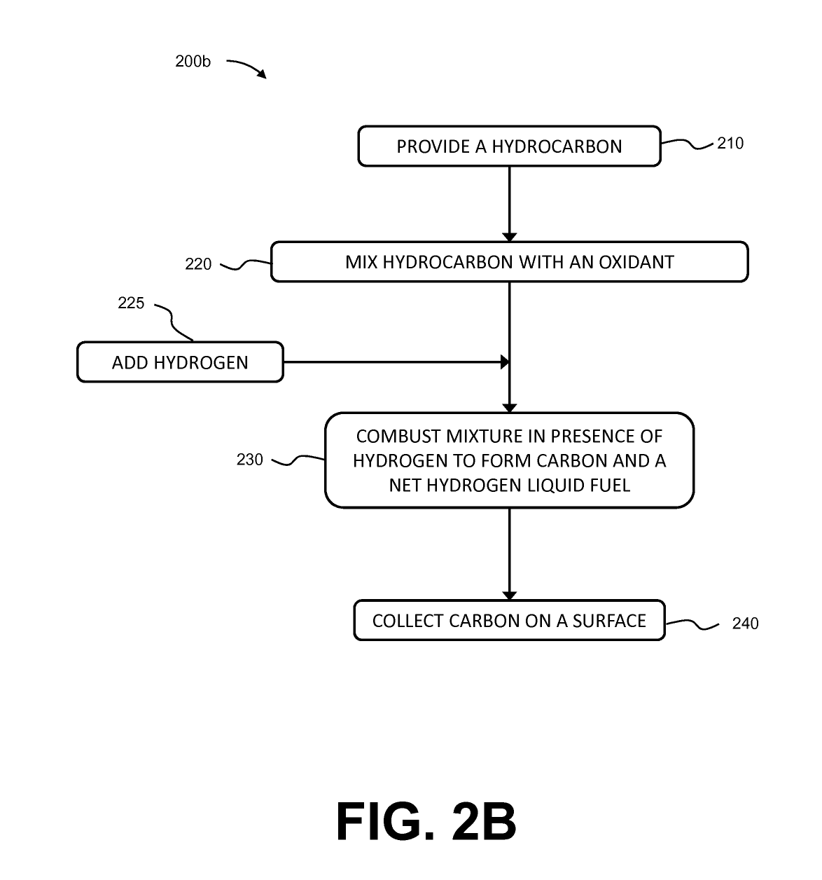

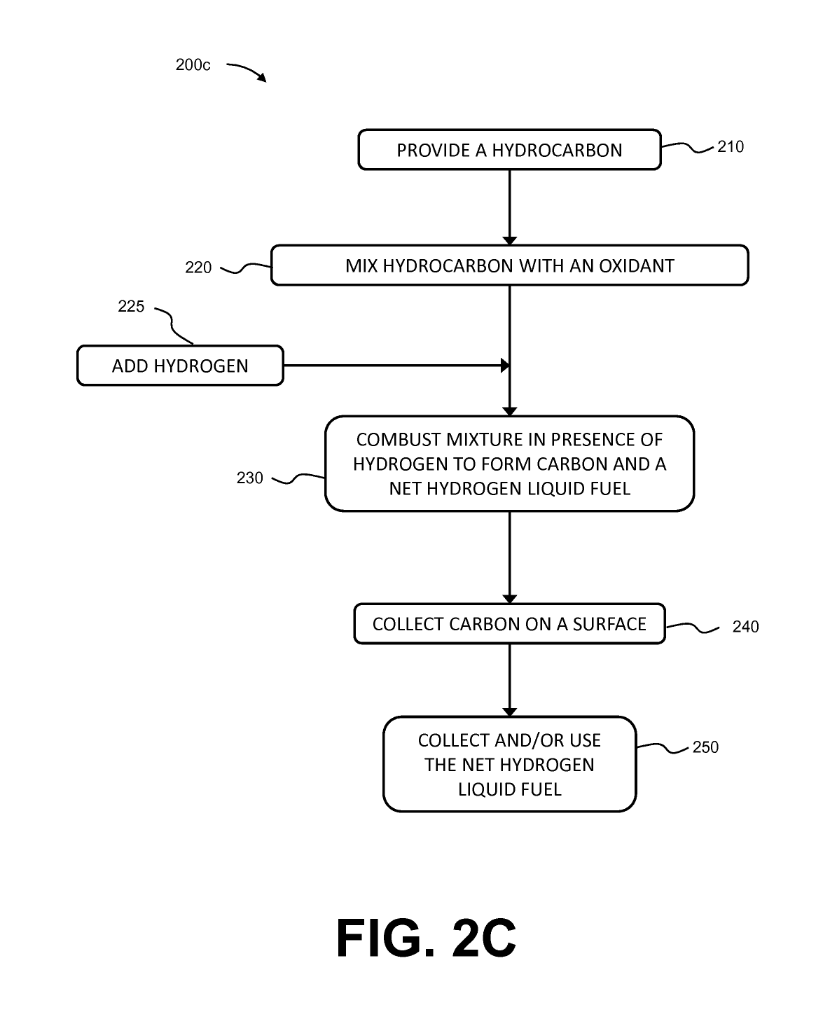

Referring now to FIG. 2A, a method 200a for producing a net hydrogen liquid fuel comprises providing a hydrocarbon in an initial step 210. The hydrocarbon is then mixed with an oxidant in a subsequent step 220 and with hydrogen in a subsequent step 225. The mixture of the hydrocarbon, oxidant and hydrogen is then combusted in a step 230 to form carbon and a net hydrogen liquid fuel.

In a similar embodiment shown in FIG. 2B, a method 200b additionally includes a process 240 for collecting the carbon on a surface. Any suitable surface configured for collecting carbon may be used. In some embodiments, the surface comprises, consists essentially of, or consists of a susceptor such as suspended or temporarily presented particles and/or other substrates such as heated filter curtain. Suitable substrates include, but are not limited to, ceramic, glass, or carbon fibers including selections such as films, threads, bundled nanotubes or particles, yarn, cloth or refractory paper as a hydrocarbon such as methane flows through the hot zone of a reactor tube.

FIG. 2C illustrates another variation, in which the method 200c further includes a process 250 for collecting and/or using the net hydrogen liquid fuel. Various concentrations such as about 5% to 45% hydrogen with methane overcomes requirements for premixing methane fuel and air along with enabling lower energy spark ignition and combustion is completed more rapidly in a wider range of fuel mixture ratios with air particularly including excess air. The net-hydrogen liquid fuels that are produced can store hydrogen more densely than cryogenic liquid hydrogen and upon use in a fuel cell or heat engine reduce or eliminate net production of greenhouse gases. Illustratively economic development opportunities are provided for hydrocarbons (i.e. methane, ethane etc.,) that are ordinarily released from substances that rot or burn. Each ton of carbon that is collected by the dissociation of carbon and hydrogen donor avoids about 3.67 tons of CO₂ that would be released into the atmosphere upon eventual oxidation after decades of hydrocarbon harm to the global atmosphere.

Similarly, much less water vapor is released to the atmosphere upon combustion of such net hydrogen liquid fuels compared to combustion of fossil fuels to produce as much heat. Illustratively, each ton of hydrogen in a fossil fuel releases nine tons of water vapor in addition to the ambient moisture or humidity. Crop residue or organic waste sourced hydrogen that is incorporated in a net-hydrogen liquid fuel or hydrogen carrier fuel (HCF) release only as much water as the amount previously used by the green plants that sourced such wastes. In instances that organic wastes source hydrogen that is utilized to produce a durable good such as a thermoset or thermoplastic polymer the surface inventory of available water is actually reduced.

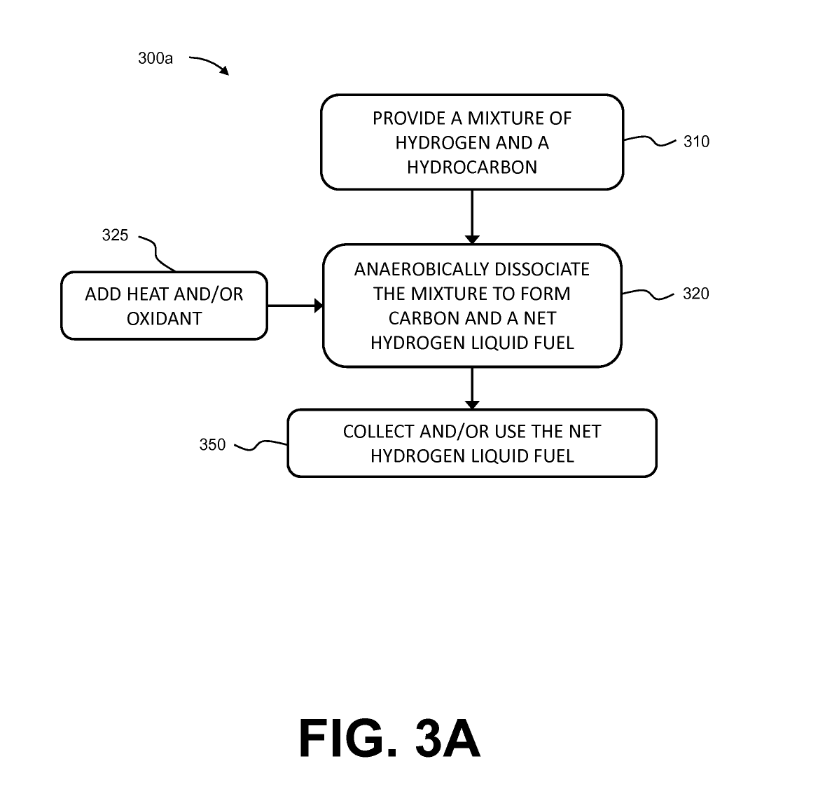

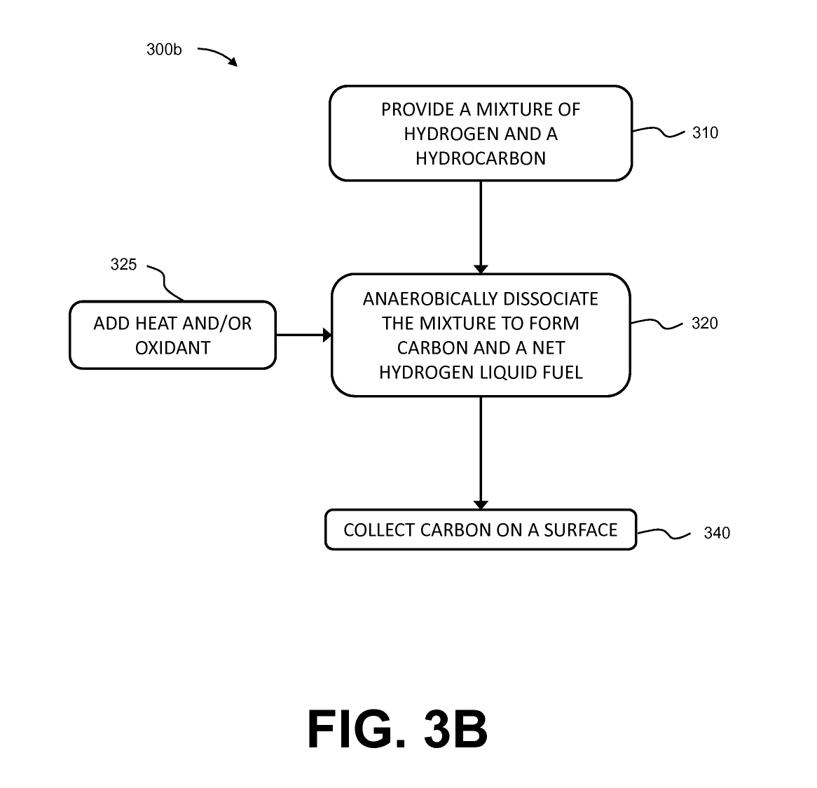

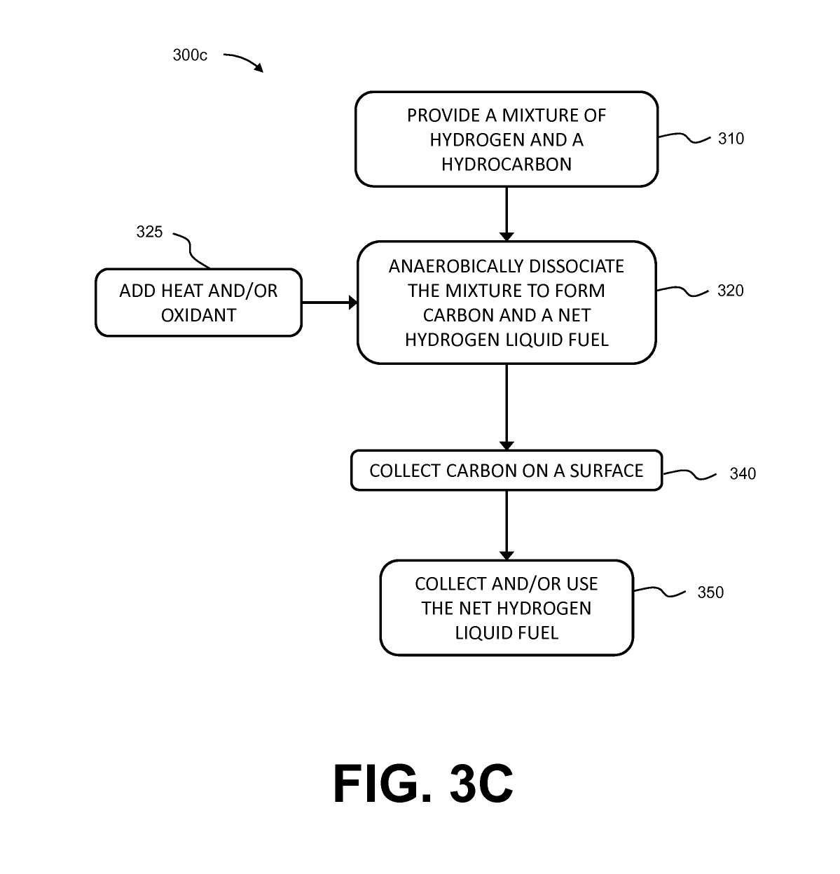

Referring now to FIG. 3A, a method 300a for producing a net hydrogen liquid fuel comprises a process 310 for providing a mixture of hydrogen and a hydrocarbon. The mixture is then anaerobically dissociated in a process 320 to form carbon and a net hydrogen liquid fuel. In some embodiments, the anaerobic dissociation is accomplished by adding heat and/or an oxidant in a process 325. The net hydrogen liquid fuel is then collected and/or used in a process 350.

In a variation illustrated in FIG. 3B, a method 300b for producing a net hydrogen liquid fuel includes processes 310, 320 and 325 as described above with respect to method 300a (FIG. 3A). The method 300b includes a step 340 for collecting carbon on a surface, similar to process 240 as described above with respect to method 200b (FIG. 2B).

FIG. 3C illustrates another variation, in which method 300c includes processes 310, 320, 325 and 350 as shown and described with respect to method 300a (FIG. 3A), and further includes a step 340 for collecting carbon on a surface, similar to process 240 as described above with respect to method 200b (FIG. 2B).

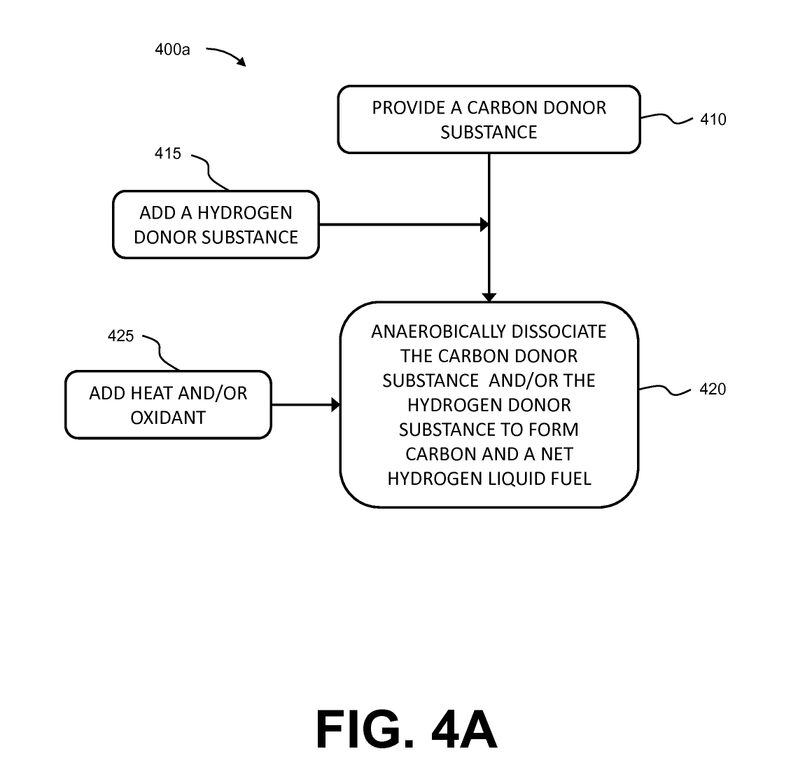

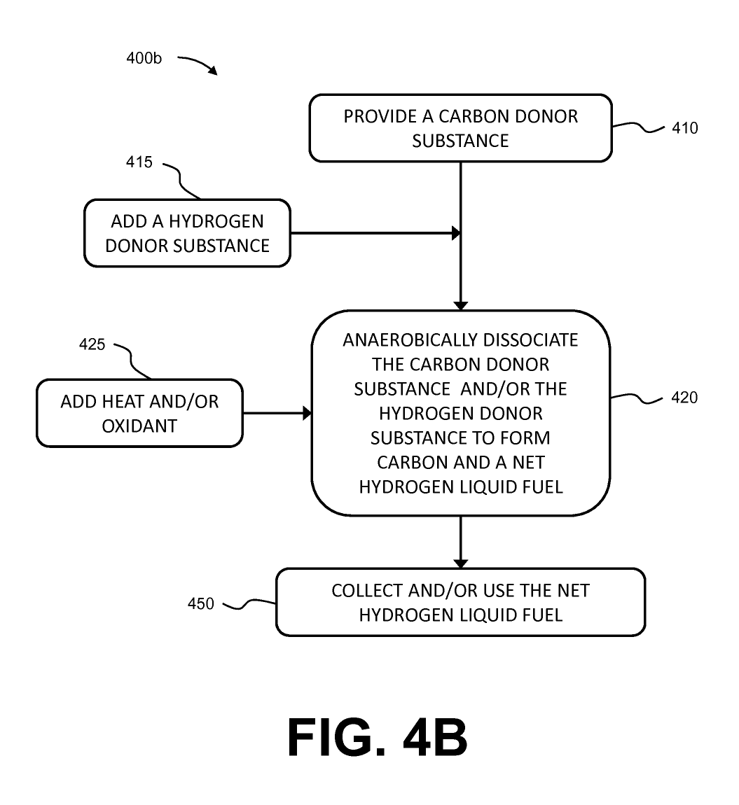

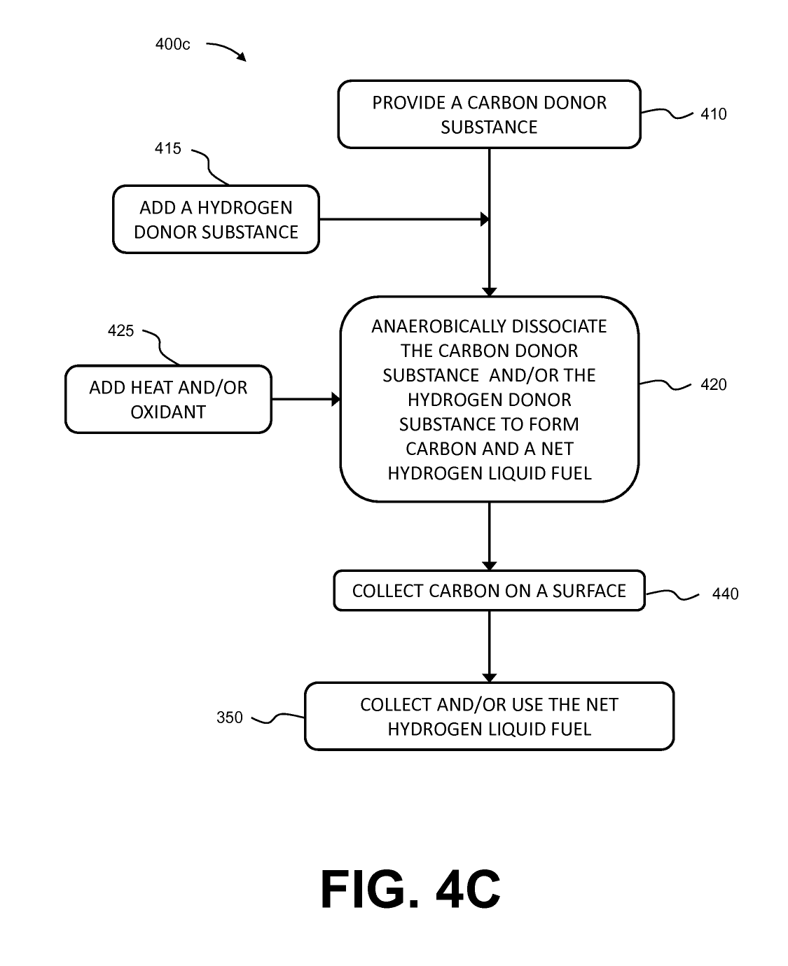

Referring now to FIG. 4A, a method 400a for producing a net hydrogen liquid fuel includes a process 410 for providing a carbon donor substance. Any suitable compound that is capable of anaerobically dissociating into one or more products including carbon may serve as the carbon donor substance. In some embodiments, the carbon donor substance comprises, consists essentially of, or consists of a hydrocarbon. Method 400a further includes a process 415 for adding a hydrogen donor substance to the carbon donor substance. The hydrogen donor substance can comprise, consist essentially of, or consist of any element or compound capable of providing hydrogen (H₂) under anaerobic dissociation conditions. Method 400a further includes a process 420 for anaerobically dissociating the carbon donor substance and/or the hydrogen donor substance to form carbon and a net hydrogen liquid fuel. In some embodiments, the anaerobic dissociation process 420 includes providing heat and/or an oxidant to the carbon donor substance and/or to the hydrogen donor substance in a process 425.

As shown in FIG. 4B, a method 400b for producing a net hydrogen liquid fuel includes processes 410, 415, 420 and 425 as shown and described with respect to method 400a (FIG. 4A). In addition, method 400b further includes a process 450 for collecting and/or using the net hydrogen liquid fuel.

As shown in FIG. 4C, a method 400c for producing a net hydrogen liquid fuel includes processes 410, 415, 420, 425 and 450 as shown and described with respect to method 400b (FIG. 4B). Method 400c additionally includes a process 440 for collecting carbon on a surface similar to process 240 shown and described with respect to method 200b (FIG. 2B).

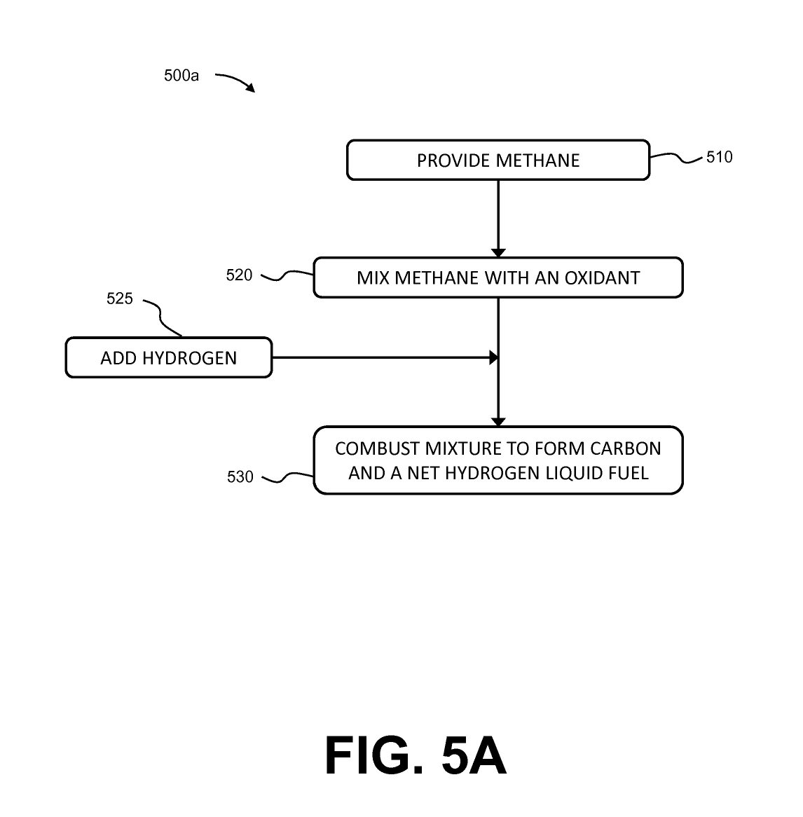

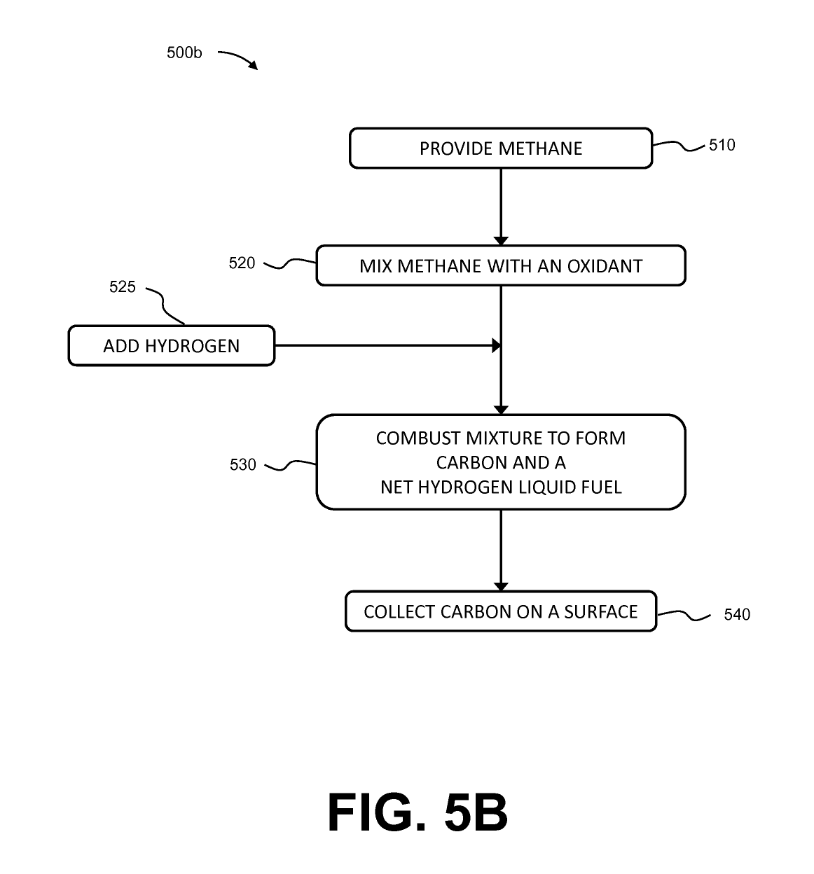

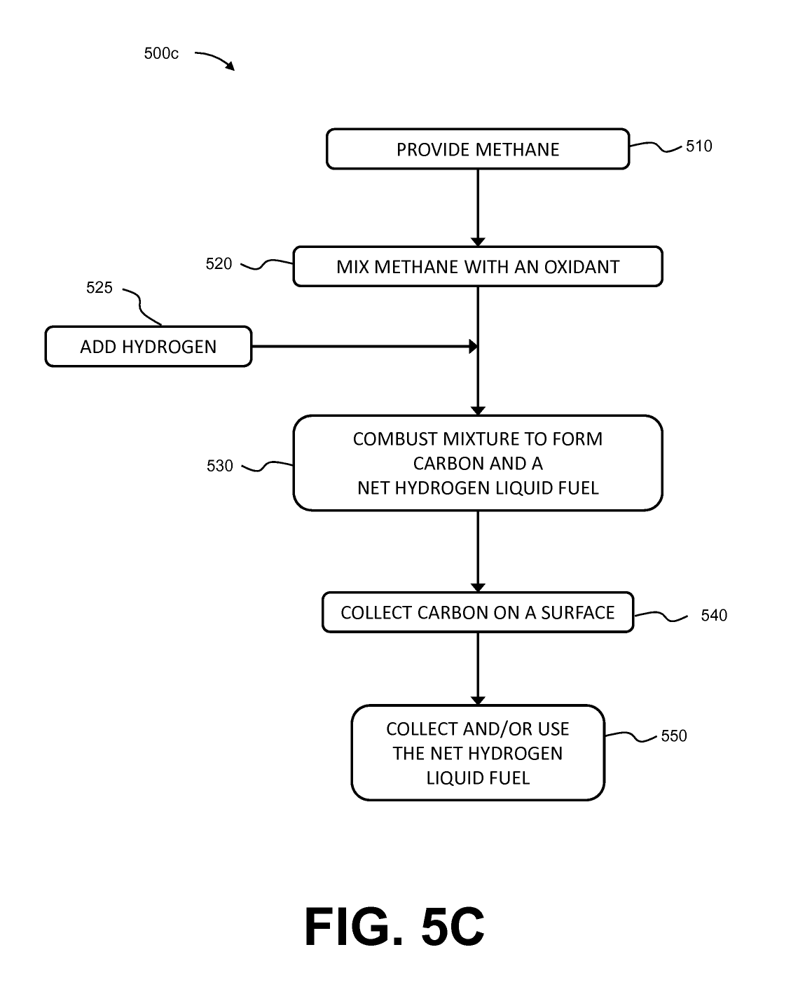

Referring now to FIG. 5A, a method 500a for producing a net hydrogen liquid fuel includes a process 510 for providing methane. In a process 520, the methane is mixed with an oxidant. Hydrogen is also mixed with the methane in a process 525, and the combination is then combusted in a process 530 to form carbon and a net hydrogen liquid fuel.

As shown in FIG. 5B, a method 500b for producing a net hydrogen liquid fuel includes processes 510, 520, 525 and 530 as shown and described above with respect to method 500a (FIG. 5A). Method 500b further includes a process 540 for collecting carbon on a surface similar to process 240 shown and described with respect to method 200b (FIG. 2B).

As shown in FIG. 5C, a method 500c for producing a net hydrogen liquid fuel includes processes 510, 520, 525, 530 and 540 as shown and described above with respect to method 500b (FIG. 5B). Method 500c further includes a process 550 for collecting and/or using the net hydrogen liquid fuel.

From the foregoing, it will be appreciated that specific embodiments of the invention have been described herein for purposes of illustration, but that various modifications may be made without deviating from the scope of the invention. Accordingly, the invention is not limited except as by the appended claims.

I/We claim:

1. A method of producing carbon and a net hydrogen liquid fuel, the method comprising:
providing a hydrocarbon;
mixing an oxidant with the hydrocarbon to form a mixture; and
combusting the mixture in the presence of hydrogen to form the carbon and the net hydrogen liquid fuel.

2. The method of claim 1 further comprising collecting the carbon on a surface.

3. The method of claim 1 further comprising collecting and/or using the net hydrogen liquid fuel.

4. The method of claim 1, wherein the hydrocarbon comprises methane.

5. The method of claim 1, wherein the oxidant comprises oxygen, air and/or an oxidizing exhaust gas.

6. The method of claim 5, wherein the oxidizing exhaust gas is obtained from an engine or a fuel cell.

7. The method of claim 1, wherein the combustion comprises, consists essentially of, or consists of anaerobic dissociation of the hydrocarbon.

8. The method of claim 7, wherein the anaerobic dissociation comprises providing heat to the hydrocarbon from one or more of: an engine coolant or oil, engine exhaust heat, induction heat, and combustion heat.

9. A method of producing a net hydrogen liquid fuel, the method comprising:
providing a mixture of hydrogen and a hydrocarbon;
anaerobically dissociating the hydrocarbon in the presence of heat and/or an oxidant to form carbon and the net hydrogen liquid fuel; and
collecting and/or using the net hydrogen liquid fuel.

10. The method of claim 9 further comprising collecting the carbon on a surface.

11. The method of claim 9 further comprising collecting and/or using the net hydrogen liquid fuel.

12. The method of claim 9, wherein the hydrocarbon comprises methane.

13. The method of claim 9, wherein the oxidant comprises oxygen, air and/or an oxidizing exhaust gas.

14. The method of claim 13, wherein the oxidizing exhaust gas is obtained from an engine or a fuel cell.

15. The method of claim 9, wherein the anaerobic dissociation comprises providing heat to the hydrocarbon from one or more of: an engine coolant or oil, engine exhaust heat, induction heat, and combustion heat.

16. A method of producing carbon and a net hydrogen liquid fuel, the method comprising:
providing a carbon donor substance;
combining a hydrogen donor substance with the carbon donor source; and
anaerobically dissociating the hydrocarbon in the presence of heat and/or an oxidant to form carbon and the net hydrogen liquid fuel.

17. The method of claim 16 further comprising collecting and/or using the net hydrogen liquid fuel.

18. The method of claim 16 further comprising collecting the carbon on a surface.

19. The method of claim 16, wherein the carbon donor source comprises methane.

20. The method of claim 16, wherein the oxidant comprises oxygen, air and/or an oxidizing exhaust gas.

21. The method of claim 20, wherein the oxidizing exhaust gas is obtained from an engine or a fuel cell.

22. The method of claim 16, wherein the combustion comprises, consists essentially of, or consists of anaerobic dissociation of the hydrocarbon.

23. The method of claim 22, wherein the anaerobic dissociation comprises providing heat to the hydrocarbon from one or more of: an engine coolant or oil, engine exhaust heat, induction heat, and combustion heat.

24. A method of producing carbon and a net hydrogen liquid fuel, the method comprising:
providing methane;
combining an oxidant with the methane to form a mixture; and
combusting the mixture in the presence of hydrogen to form carbon and the net hydrogen liquid fuel.

25. The method of claim 24 further comprising collecting and/or using the net hydrogen liquid fuel.

26. The method of claim 24 further comprising collecting the carbon on a surface.

27. The method of claim 24, wherein the oxidant comprises oxygen, air and/or an oxidizing exhaust gas.

28. The method of claim 27, wherein the oxidizing exhaust gas is obtained from an engine or a fuel cell.

29. The method of claim 24, wherein the combustion comprises, consists essentially of, or consists of anaerobic dissociation of the hydrocarbon.

30. The method of claim 29, wherein the anaerobic dissociation comprises providing heat to the hydrocarbon from one or more of: an engine coolant or oil, engine exhaust heat, induction heat, and combustion heat.

31. The method of claim 1, wherein the net hydrogen liquid fuel comprises about 5% to about 45% hydrogen.
